(19) United States
(12) Patent Application Publication
(10) Pub. No.: US 2026/0361351 A1
(43) Pub. Date: Nov. 12, 2026

(54) NON-CODEBOOK BASED TRANSMISSION WITH DISCRETE FOURIER TRANSFORM SPREAD ORTHOGONAL FREQUENCY DIVISION MULTIPLEXING (DFT-S-OFDM) WAVEFORM

(71) Applicant: Google LLC, Mountain View, CA (US)

(72) Inventors: Yushu ZHANG, Beijing (CN); Jia-Hong LIOU, Taipei City (TW)

(21) Appl. No.: 19/515,230

(22) PCT Filed: Aug. 31, 2023
(86) PCT No.: PCT/CN2023/116264

§ 371 Date: Feb. 27, 2026

(51) Int. Cl. H04B 7/0456; H04L 5/00

(52) U.S. Cl. CPC H04B 7/0473; H04L 5/0007; H04L 5/0048

(57) ABSTRACT

This disclosure provides systems, devices, apparatus, and methods, including computer programs encoded on storage media, for a non-codebook based transmission with a DFT-s-OFDM waveform. A UE receives (710), from a network entity (104), a configuration indicating an SRS resource set. The UE (120) transmits (730), to the network entity (104), a plurality of SRSs via the SRS resource set. The UE (102) receives (740), from the network entity (104), an uplink grant scheduling a PUSCH based on a transform precoding enabled OFDM waveform, the uplink grant indicating an SRS resource indicator (SRI) associated with the SRS resource set. The UE (102) transmits (750), to the network entity (104) based on a first precoder indicated by the SRI, the PUSCH using the transform precoding enabled OFDM waveform, the first precoder comprising a rank of at least two layers.

### TECHNICAL FIELD

The present disclosure relates generally to wireless communication, and more particularly, to non-codebook based transmission with DFT-s-OFDM waveform.

### BACKGROUND

The Third Generation Partnership Project (3GPP) specifies a radio interface referred to as fifth generation (5G) new radio (NR) (5G NR). An architecture for a 5G NR wireless communication system includes a 5G core (5GC) network, a 5G radio access network (5G-RAN), a user equipment (UE), etc. The 5G NR architecture seeks to provide increased data rates, decreased latency, and/or increased capacity compared to prior generation cellular communication systems.

A user equipment (UE) may transmit a physical uplink shared channel (PUSCH) communication using either a transform precoding enabled orthogonal frequency division multiplexing (OFDM) waveform (e.g., discrete Fourier transform spread OFDM (DFT-s-OFDM) waveform) or a transform precoding disabled OFDM waveform (e.g., cyclic prefix OFDM (CP-OFDM) waveform). A network entity configures the waveform for the PUSCH by a radio resource control (RRC) message or uplink scheduling downlink control information (DCI). While the network entity may configure a PUSCH with up to 8 layers based on a CP-OFDM waveform, the network entity may be limited in configuring a PUSCH with multiple layers based on a DFT-s-OFDM waveform.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In order to improve network coverage and throughput for uplink transmissions, aspects of the present disclosure introduce multi-layer PUSCH transmission based on a transform precoding enabled OFDM waveform (e.g., DFT-s-OFDM waveform). Compared to a transform precoding disabled OFDM waveform (e.g., CP-OFDM waveform), the transform precoding enabled OFDM waveform has a lower peak to average power ratio (PAPR) and provides a high power-amplifier efficiency enabling higher uplink transmission power and coverage.

In order to maintain a low PAPR in multi-layer PUSCH transmission using the transform precoding enabled OFDM waveform, the precoder may be defined based on a principle that each UE antenna port is only mapped to one layer. In keeping with this principle, the precoder uses different layers mapped to different UE antenna ports. That is, the precoder is based on each UE antenna port being mapped to no more than one layer.

The network entity configures the UE (e.g., via RRC, DCI, or a medium access control-control element (MAC-CE)) with at least one sounding reference signal (SRS) resource set for non-codebook based transmission using the transform precoding enabled OFDM waveform. The UE receives a channel state information reference signal (CSI-RS) and estimates the channel based on the CSI-RS. The uplink and downlink channels may be reciprocal and the UE may transmit SRSs in the configured SRS resources using a precoder based on the downlink channel estimation. The network entity measures the SRSs and determines a precoder for the PUSCH based on the measurements. The network entity transmits an uplink grant to the UE for scheduling the PUSCH based on the transform precoding enabled OFDM waveform. The uplink grant indicates the precoder, the number of layers, the time/frequency resources for the PUSCH, and other parameters. The UE transmits the PUSCH based on the uplink grant. The precoder may be indicated by an SRS resource indicator (SRI). The SRI may indicate a combination of SRS resources while maintaining the principle that each UE antenna port is mapped to no more than one layer.

According to some aspects, a UE receives, from a network entity, a configuration indicating an SRS resource set. The UE transmits, to the network entity, a plurality of SRSs via the SRS resource set. The UE receives, from the network entity, an uplink grant scheduling a PUSCH using a transform precoding enabled OFDM waveform. The uplink grant indicates an SRI based on the SRS resource set. The UE transmits, to the network entity, the PUSCH using the transform precoding enabled OFDM waveform and based on a first precoder indicated by the SRI. The first precoder comprises a rank of at least two layers.

According to some aspects, a network entity transmits, to a UE, a configuration indicating an SRS resource set. The network entity receives, from the UE, a plurality of SRSs via the SRS resource set. The network entity transmits, to the UE, an uplink grant scheduling a PUSCH using a transform precoding enabled OFDM waveform. The uplink grant indicates an SRI based on the SRS resource set. The network entity receives, from the UE, the PUSCH using the transform precoding enabled OFDM waveform and based on a first precoder indicated by the SRI. The first precoder comprises a rank of at least two layers.

Technical benefits of the present disclosure include improving uplink coverage and performance by using a transform precoding enabled OFDM waveform for multi-layer PUSCH communications. Technical benefits of the present disclosure further include lowering the PAPR of the OFDM waveform and improving UE power efficiency.

### BRIEF DESCRIPTION OF THE DRAWINGS

FIG. 1 illustrates a diagram of a wireless communications system that includes a plurality of UEs and network entities in communication over one or more cells according to an embodiment.

FIG. 2 illustrates a diagram of SRS resource allocation for non-codebook based transmission with DFT-s-OFDM waveform according to an embodiment.

FIG. 3 illustrates a diagram of various combinations of SRS resources for non-codebook based transmission with DFT-s-OFDM waveform according to an embodiment.

FIG. 4 illustrates a diagram of non-zero power (NZP) ports of SRS resources for non-codebook based transmission with DFT-s-OFDM waveform according to an embodiment.

FIG. 5 illustrates a diagram of SRS resource sets for non-codebook based transmission with DFT-s-OFDM waveform according to an embodiment.

FIG. 6 illustrates a diagram of non-zero power (NZP) port combinations of SRS resources for non-codebook based transmission with DFT-s-OFDM waveform according to an embodiment.

FIG. 7 illustrates a signaling diagram for multi-layer non-codebook based transmission with DFT-s-OFDM waveform according to an embodiment.

FIG. 8 is a flowchart of a method of wireless communication at a UE according to an embodiment.

FIG. 9 is a flowchart of a method of wireless communication at a network entity according to an embodiment.

FIG. 10 is a diagram illustrating a hardware implementation for an example UE apparatus according to some embodiments.

FIG. 11 is a diagram illustrating a hardware implementation for one or more example network entities according to some embodiments.

### DETAILED DESCRIPTION

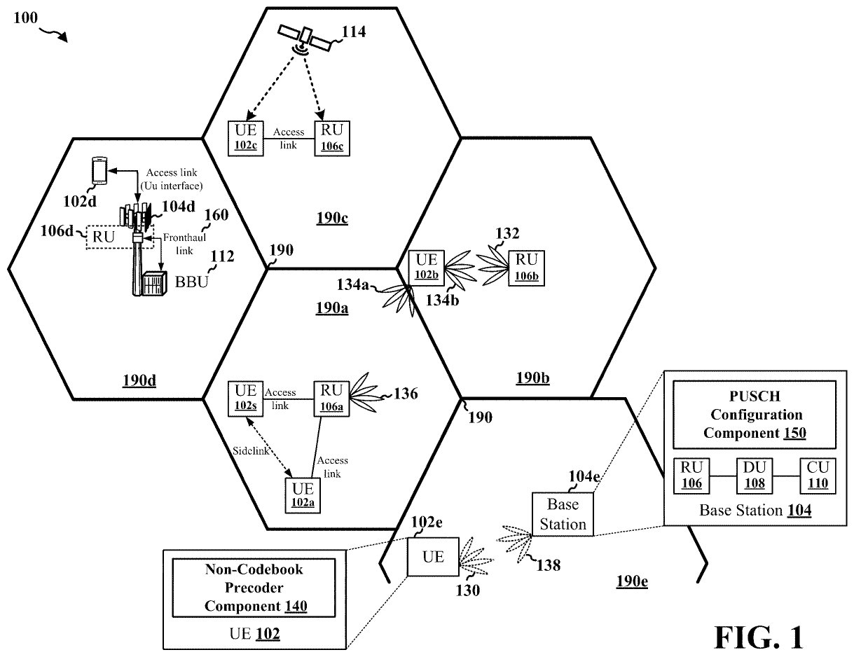

FIG. 1 illustrates a diagram 100 of a wireless communications system associated with a plurality of cells 190. The wireless communications system includes user equipments (UEs) 102 and base stations/network entities 104. Some base stations may include an aggregated base station architecture and other base stations may include a disaggregated base station architecture. The aggregated base station architecture utilizes a radio protocol stack that is physically or logically integrated within a single radio access network (RAN) node. A disaggregated base station architecture utilizes a protocol stack that is physically or logically distributed among two or more units (e.g., radio unit (RU) 106, distributed unit (DU) 108, central unit (CU) 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Any of the RU 106, the DU 108 and the CU 110 can be implemented as virtual units, such as a virtual radio unit (VRU), a virtual distributed unit (VDU), or a virtual central unit (VCU). The base station/network entity 104 (e.g., an aggregated base station or disaggregated units of the base station, such as the RU 106 or the DU 108), may be referred to as a transmission reception point (TRP).

Operations of the base station 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN), which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the base stations 104d, 104e and/or the RUs 106a, 106b, 106c, 106d may communicate with the UEs 102a, 102b, 102c, 102d, and/or 102s via one or more radio frequency (RF) access links based on a Uu interface. In examples, multiple RUs 106 and/or base stations 104 may simultaneously serve the UEs 102, such as by intra-cell and/or inter-cell access links between the UEs 102 and the RUs 106/base stations 104.

The RU 106, the DU 108, and the CU 110 may include (or may be coupled to) one or more interfaces configured to transmit or receive information/signals via a wired or wireless transmission medium. For example, a wired interface can be configured to transmit or receive the information/signals over a wired transmission medium, such as via the fronthaul link 160 between the RU 106d and the baseband unit (BBU) 112 of the base station 104d associated with the cell 190d. The BBU 112 includes a DU 108 and a CU 110, which may also have a wired interface (e.g., midhaul link) configured between the DU 108 and the CU 110 to transmit or receive the information/signals between the DU 108 and the CU 110. In further examples, a wireless interface, which may include a receiver, a transmitter, or a transceiver, such as an RF transceiver, configured to transmit and/or receive the information/signals via the wireless transmission medium, such as for information communicated between the RU 106a of the cell 190a and the base station 104e of the cell 190e via cross-cell communication beams 136-138 of the RU 106a and the base station 104e.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RU 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or, in some examples, cross-cell communication beams. For instance, the UE 102b of the cell 190b may communicate with the RU 106a of the cell 190a via a third set of communication beams 134a of the UE 102b and a fourth set of communication beams 136 of the RU 106a. DUs 108 can control both real-time and non-real-time features of control plane and user plane communications of the RUs 106.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to a core network. The base stations 104 may relay communications between the UEs 102 and the core network (not shown). The base stations 104 may be associated with macrocells for higher-power cellular base stations and/or small cells for lower-power cellular base stations. For example, the cell 190e may correspond to a macrocell, whereas the cells 190a-190d may correspond to small cells. Small cells include femtocells, picocells, microcells, etc. A network that includes at least one macrocell and at least one small cell may be referred to as a “heterogeneous network.”

Transmissions from a UE 102 to a base station 104/RU 106 are referred to as uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104d of cell 190d to transmit a downlink/forward link communication to the UE 102d or receive an uplink/reverse link communication from the UE 102d based on the Uu interface associated with the access link between the UE 102d and the base station 104d/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, with more or fewer carriers allocated to either the uplink or the downlink. A primary component carrier and one or more secondary component carriers may be included in the component carriers. The primary component carrier may be associated with a primary cell (PCell) and a secondary component carrier may be associated with a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. Such sidelink/D2D communication may be performed through various wireless communications systems, such as wireless fidelity (Wi-Fi) systems, Bluetooth systems, Long Term Evolution (LTE) systems, New Radio (NR) systems, etc.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of communication beams 132 to the UE 102b in one or more transmit directions of the RU 106b. The UE 102b may receive the downlink beamformed signal based on a second set of communication beams 134b from the RU 106b in one or more receive directions of the UE 102b. In a further example, the UE 102b may also transmit an uplink beamformed signal (e.g., sounding reference signal (SRS)) to the RU 106b based on the second set of communication beams 134b in one or more transmit directions of the UE 102b. The RU 106b may receive the uplink beamformed signal from the UE 102b in one or more receive directions of the RU 106b. The UE 102b may perform beam training to determine the best receive and transmit directions for the beamformed signals. The transmit and receive directions for the UEs 102 and the base stations 104/RUs 106 may or may not be the same.

In further examples, beamformed signals may be communicated between a first base station/RU 106a and a second base station 104e. For instance, the base station 104e of the cell 190e may transmit a beamformed signal to the RU 106a based on the communication beams 138 in one or more transmit directions of the base station 104e. The RU 106a may receive the beamformed signal from the base station 104e of the cell 190e based on the RU communication beams 136 in one or more receive directions of the RU 106a. In further examples, the base station 104e transmits a downlink beamformed signal to the UE 102e based on the communication beams 138 in one or more transmit directions of the base station 104e. The UE 102e receives the downlink beamformed signal from the base station 104e based on UE communication beams 130 in one or more receive directions of the UE 102e. The UE 102e may also transmit an uplink beamformed signal to the base station 104e based on the UE communication beams 130 in one or more transmit directions of the UE 102e, such that the base station 104e may receive the uplink beamformed signal from the UE 102e in one or more receive directions of the base station 104e.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a next generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station, or a disaggregated base station including one or more RUs 106, DUs 108, and/or CUs 110. A set of aggregated or disaggregated base stations may be referred to as a next generation-radio access network (NG-RAN). In some examples, the UE 102a operates in dual connectivity (DC) with the base station 104e and the base station/RU 106a. In such cases, the base station 104e can be a master node and the base station/RU 160a can be a secondary node.

Uplink/downlink signaling may also be communicated via a satellite positioning system (SPS) 114. In an example, the SPS 114 associated with the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

Still referring to FIG. 1, in certain aspects, any of the UEs 102 may include a non-codebook precoder component 140 configured to receive, from a network entity, a configuration indicating an SRS resource set; transmit, to the network entity, a plurality of SRSs via the SRS resource set; receive, from the network entity, an uplink grant scheduling a PUSCH based on a transform precoding enabled OFDM waveform, the uplink grant indicating an SRI associated with the SRS resource set; and transmit, to the network entity based on a first precoder indicated by the SRI, the PUSCH using the transform precoding enabled OFDM waveform, the first precoder comprising a rank of at least two layers.

In certain aspects, any of the base stations 104 or a network entity of the base stations 104 may include a PUSCH configuration component 150 configured to: transmit, to a UE, a configuration indicating an SRS resource set; receive, from the UE, a plurality of SRSs via the SRS resource set; transmit, to the UE, an uplink grant scheduling a PUSCH based on a transform precoding enabled OFDM waveform, the uplink grant indicating an SRI associated with the SRS resource set; and receive, from the UE based on a first precoder indicated by the SRI, the PUSCH using the transform precoding enabled OFDM waveform, the first precoder comprising a rank of at least two layers.

Accordingly, FIG. 1 describes a wireless communication system that may be implemented in connection with aspects of one or more other figures described herein. Further, although the following description may be focused on 5G NR, the concepts described herein may be applicable to other similar areas, such as 5G-Advanced and future versions, LTE, LTE-advanced (LTE-A), and other wireless technologies, such as 6G.

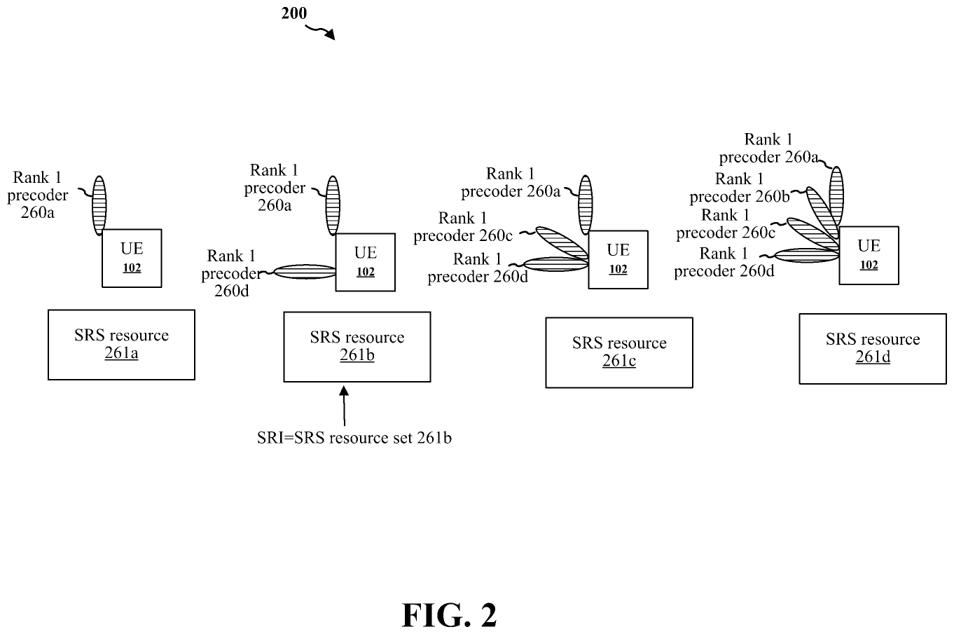

FIG. 2 illustrates a diagram 200 of SRS resource allocation for non-codebook based transmission with DFT-s-OFDM waveform according to an embodiment. A network entity may configure a CP-OFDM waveform and/or a DFT-s-OFDM waveform for PUSCH transmission. The network entity may configure the waveform for PUSCH transmission via RRC messaging or a scheduling DCI. In some aspects, the network entity configures a DFT-s-OFDM waveform for the PUSCH using multiple layers (e.g., a rank greater than 1). The network entity may configure the multi-layer PUSCH using a non-codebook based transmission scheme.

In a non-codebook based transmission scheme, the network entity may configure a set of SRS resources. In some aspects, the UE applies different rank 1 precoders to different SRS resources to transmit the SRSs to the network entity. The UE may receive a CSI-RS from the network entity and estimate the channel based on the CSI-RS. The uplink and downlink channels may be reciprocal and the UE may transmit SRSs in the configured SRS resources using a precoder based on the downlink channel estimation.

In order to improve network coverage and throughput for uplink transmission, the present disclosure provides for multi-layer PUSCH transmission based on a DFT-s-OFDM waveform. The DFT-s-OFDM waveform may have a lower peak to average power ratio (PAPR) as compared to a CP-OFDM waveform and may provide a high power amplifier efficiency at the UE. Further, the low PAPR DFT-s-OFDM waveform may support higher uplink transmission power. However, to maintain a low PAPR for the multi-layer PUSCH with DFT-s-OFDM waveform, the non-codebook based transmission scheme maintains the principle that each UE antenna port is mapped to no more than one layer (e.g., a precoder with different layers is mapped to different antenna ports). That is, a precoder with different layers is mapped to different antenna ports so that each row of the precoder matrix has only one non-zero coefficient.

In some aspects, the network entity may configure a first SRS resource set for non-codebook based transmission with DFT-s-OFDM waveform and a second, different SRS resource set for non-codebook based transmission with CP-OFDM waveform. In some aspects, the network entity configures the DFT-s-OFDM waveform for the PUSCH transmission by configuring the transform precoder as enabled (e.g., parameter transformPrecoder enabled) and configures the CP-OFDM waveform for the PUSCH transmission by configuring the transform precoder as disabled (e.g., parameter transformPrecoder disabled).

In some aspects, the UE determines the target waveform for the SRS resource set based on the configured waveforms for PUSCH transmission, whether dynamic waveform switching is enabled or disabled, and/or the SRS resource set identifier (ID). For example, if dynamic waveform switching is disabled, the UE determines the target waveform for the SRS resource set based on the waveform configured for PUSCH transmission. Otherwise, the UE determines the target waveform for the SRS resource set based on the SRS resource set ID.

In some aspects, the network entity may configure a common SRS resource set for non-codebook based transmission for both DFT-s-OFDM waveform and CP-OFDM waveform. The network entity may explicitly indicate (e.g., via RRC messaging, MAC CE, or DCI) whether an SRS resource set for non-codebook based transmission is for a DFT-s-OFDM waveform or a CP-OFDM waveform, or both DFT-s-OFDM waveform and CP-OFDM waveform. Additionally or alternatively, the UE may determine whether the SRS resource set is for non-codebook based transmission of both DFT-s-OFDM waveform and CP-OFDM waveform based on whether dynamic waveform switching is enabled or disabled. For example, if dynamic waveform switching is enabled, the UE determines the SRS resource set for non-codebook based transmission is for both DFT-s-OFDM waveform and CP-OFDM waveform. Otherwise, the UE determines the SRS resource set is for the waveform configured for PUSCH transmission. In some aspects, a portion (e.g., half) of the SRS resource sets are used for CP-OFDM waveform and the remaining portion of the SRS resource sets are used for DFT-s-OFDM waveform.

In some aspects, the network entity configures each of the SRS resources 261 for non-codebook based transmission with DFT-s-OFDM waveform with one or more antenna ports. The network entity may configure a different number of antenna ports for different SRS resources 261. The network entity may configure the amount of SRS resources 261 to be equal to or less than the maximum number of UE supported layers/antenna ports for non-codebook based PUSCH transmission with DFT-s-OFDM waveform. The UE may transmit the SRSs based on precoders with different ranks (optionally in ascending order). In one example, the UE transmits an x port SRS resource based on a rank x precoder. For example, referring to the non-limiting example of FIG. 2, the UE may be configured with up to four antenna ports for the SRS transmission. The UE may be configured to transmit any combination of rank 1 precoders 260a-260d using any number of antenna ports limited by the number of antenna ports of the UE. For example, the UE may be configured to transmit SRS on SRS resource 261a using a single antenna port. Additionally or alternatively, the UE may be configured to transmit SRS on SRS resource 261b using two antenna ports. Additionally or alternatively, the UE may be configured to transmit SRS on SRS resource 261c using three antenna ports. Additionally or alternatively, the UE may be configured to transmit SRS on SRS resource 261d using four antenna ports.

The network entity measures the SRS on SRS resources 261 transmitted by the UE and determines an SRI based on the measurements. The network entity indicates (e.g., via RRC messaging or DCI) the precoder for the PUSCH by an SRI indicating one of the configured SRS resources 261. In the example of FIG. 2, the SRI indicates SRS resource 261b with rank 1 precoders 260a and 260d using two antenna ports. The UE transmits the PUSCH using the same rank 1 precoder 260a and 260d. The UE transmits the PUSCH using x layers if an SRS resource with x ports is indicated. For example, the UE transmits the PUSCH using two layers with the same rank 1 precoder 260a and 260d as the indicated SRS resource 261b.

In some aspects, for dynamic-grant based PUSCH transmission, the UE transmits the PUSCH associated with the most recently indicated SRS resource transmitted and/or applied prior to the scheduling DCI. For configured-grant based PUSCH transmission, the UE transmits the PUSCH associated with the most recently indicated SRS resource transmitted and/or applied prior to the K slots or symbols before the first symbol of the PUSCH, where K may be predefined or configured by RRC signaling or reported by the UE via a UE capability report.

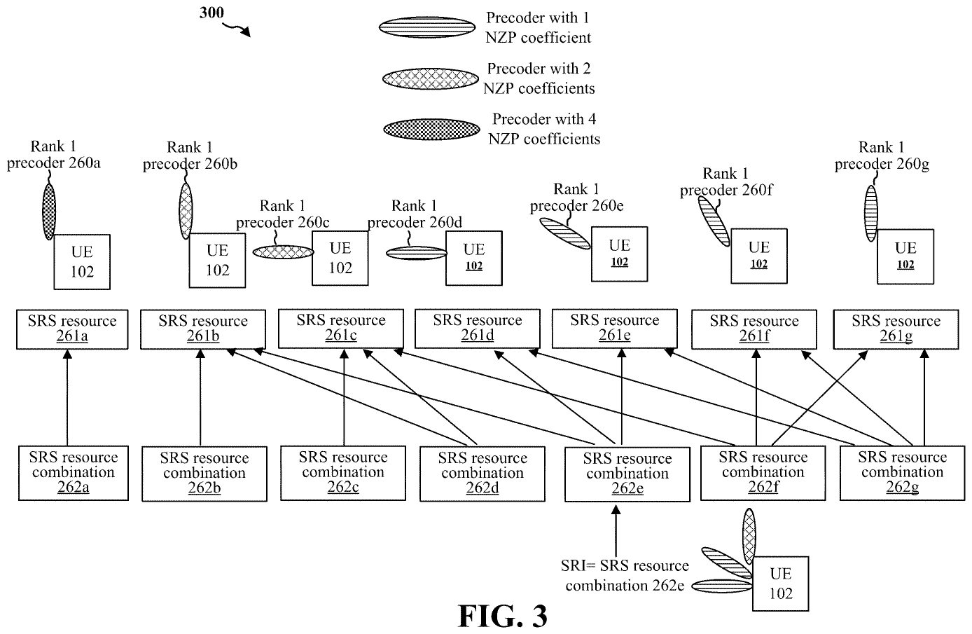

FIG. 3 illustrates a diagram 300 of various combinations of SRS resources for non-codebook based transmission with DFT-s-OFDM waveform according to an embodiment. In some aspects, the network entity configures (e.g., via RRC messaging or MAC CE) candidate SRS resource combinations for the precoder indication for non-codebook based PUSCH transmission with DFT-s-OFDM waveform. In the non-limiting example of FIG. 3, the network entity configures seven different SRS resource combinations 262a-262g using rank 1 precoders 260a-260d for transmission by up to four UE antenna ports. The network entity may indicate a rank x transmission for PUSCH by indicating x SRS resources from the set of SRS resources. The UE then applies the same rank 1 precoder 260 for transmitting the indicated SRS resources 261 to transmit the PUSCH. SRS resource combination 262a may include a single SRS resource 261a configured for rank one transmissions using rank 1 precoder 260a and four antenna ports. SRS resource combination 262b may include a single SRS resource 261b configured for rank one transmissions using rank 1 precoder 260b and two antenna ports. Although the beams corresponding to SRS resources 261a and 261b share the same direction, the beam width may be different. For example, the beam width corresponding to SRS resource 261a is narrower than the beam width corresponding to SRS resource 261b since SRS resource 261a is transmitted using four antenna ports and SRS resource 261b is transmitted using two antenna ports (e.g., precoders having a different number of NZP coefficients). SRS resource combination 262c may include a single SRS resource 261c configured for rank one transmissions using rank 1 precoder 260c and two antenna ports different from the two antenna ports used by SRS resource combination 261b. SRS resource combination 262d may include two SRS resources 261b and 261c configured for rank two transmissions using rank 1 precoders 260b, 260c and two antenna ports for a first layer and two other antenna ports for a second layer. SRS resource combination 262e may include three SRS resources 261b, 261d, and 261e configured for rank three transmissions using rank 1 precoders 260b, 260d, 260e, and two antenna ports for SRS resources 261b, one antenna port for SRS resources 261d, and one antenna port for SRS resources 261e. Similarly, SRS resource combination 262f may include three SRS resources 261c, 261f, and 261g configured for rank three transmissions using rank 1 precoders 260c, 260f, 260g, and two antenna ports for SRS resources 261c, one antenna port for SRS resources 261f, and one antenna port for SRS resources 261g. SRS resource combination 262g may include four SRS resources 261d, 261e, 261f, and 261g configured for rank four transmissions using rank 1 precoders 260d, 260e, 260e, 260f, and one antenna port for SRS resources 261d, one antenna port for SRS resources 261e, one antenna port for SRS resource 261f, and one antenna port for SRS resources 261g.

The network entity transmits the precoder via an SRI indicating one of the candidate SRS resource combinations 262a-262g. For example, the SRI may indicate an SRI resource combination index that corresponds to the SRS resource combination 262 selected by the network entity. In the non-limiting example of FIG. 3, the SRI indicates SRS resource combination 262e for the PUSCH transmission.

The UE may determine the NZP coefficients of the precoder for each SRS resource 261 based on the SRI indicating the candidate SRS resource combinations 262. In one example, if two SRS resources are configured in one SRS combination and the UE determines a rank 2 precoder as

$$\frac{1}{2} [ \begin{matrix}1 & 0 \\ 0 & 1 \\ 1 & 0 \\ 0 & - 1\end{matrix} ] ,$$

then the UE may transmit the two SRSs based on precoder

$$\frac{1}{2} [ \begin{matrix}1 \\ 0 \\ 1 \\ 0\end{matrix} ] and \frac{1}{2} [ \begin{matrix}0 \\ 1 \\ 0 \\ - 1\end{matrix} ]$$

respectively.

In some aspects, the SRS resources 261 in different SRS resource combinations 262 may be orthogonal. In some aspects, different SRS resource combinations 262 may be overlapping in the time domain. The network entity may refrain from configuring the SRS resources 261 corresponding to different SRS resource combinations 262 in partially or fully overlapping symbols such that the UE transmits the rank 1 precoders 260 in non-overlapping symbols. The UE may indicate to the network entity whether it supports simultaneous transmission of rank 1 precoders 260 corresponding to SRS resource combinations 262 overlapping in the time domain.

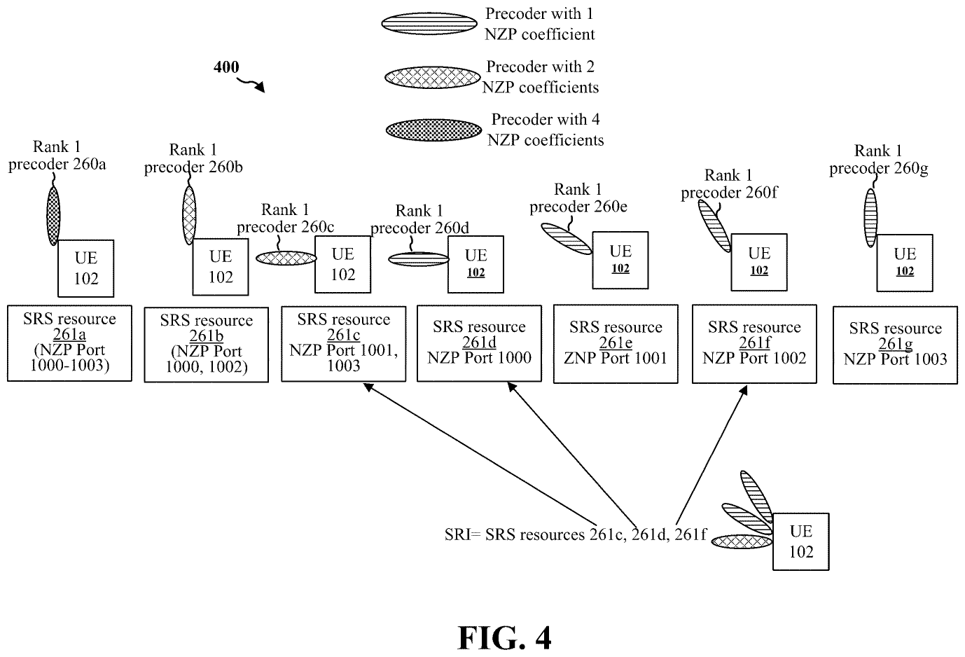

FIG. 4 illustrates a diagram 400 of non-zero power (NZP) ports of SRS resources for non-codebook based transmission with DFT-s-OFDM waveform according to an embodiment. In some aspects, a network entity configures the associated NZP PUSCH port(s) index(es) for an SRS resource for non-codebook based transmission with DFT-s-OFDM waveform. The UE determines the NZP coefficients for the precoder for the SRS resource according to the NZP PUSCH port(s) index indicated in the SRI. When indicating the SRI, the network entity maintains the principle that each UE antenna port is mapped to no more than one layer by refraining from indicating the SRS resources with overlapping NZP PUSCH port(s).

In the non-limiting example of FIG. 4, the network entity configures seven different SRS resources 261a-261g for transmission by up to four antenna ports. SRS resource 261a is configured for rank 1 precoder 260a on four antenna ports 1000-1003. SRS resource 261b is configured for rank 1 precoder 260b on two antenna ports 1000 and 1002. SRS resource 261c is configured for rank 1 precoder 260c on two antenna ports 1001 and 1003. SRS resource 261d is configured for rank 1 precoder 260d on antenna port 1000. SRS resource 261e is configured for rank 1 precoder 260e on antenna port 1001. SRS resource 261f is configured for rank 1 precoder 260f on antenna port 1002. SRS resource 261g is configured for rank 1 precoder 260g on antenna port 1003.

In the non-limiting example of FIG. 4, the network entity transmits an SRI indicating three SRS resources 261c, 261d, and 261f configured for rank three transmissions using two antenna ports 1001 and 1003 for SRS resources 261c, one antenna port 1000 for SRS resources 261d and one antenna port 1002 for SRS resources 261f. Based on the SRI indicating SRS resources 261c, 261d, and 261f, the UE transmits a first layer using rank 1 precoder 260c on antenna ports 1001 and 1003, a second layer using rank 1 precoder 260d on antenna port 1000, and a third layer using rank 1 precoder 260f on antenna port 1002.

In some aspects, the network entity configures the associated NZP PUSCH ports using a bit map with

$${N}_{p}^{cap} bits$$

indicating an SRS resource, where

$${N}_{p}^{cap}$$

indicates the maximum number of SRS ports or used PUSCH ports that the UE reports via UE capability report. The first state of bit x may indicate the PUSCH port x is a ZP port and the second state of bit x may indicate the PUSCH port x is an NZP port. In one example, if the network entity configures the NZP PUSCH port(s) as the first and third PUSCH antenna ports (e.g., port 1000 and 1002), the UE may determine the NZP coefficients for the precoder are the coefficients in the first and third row. For example, the precoder may be

$$\frac{1}{2} [ \begin{matrix}1 \\ 0 \\ 1 \\ 0\end{matrix} ] .$$

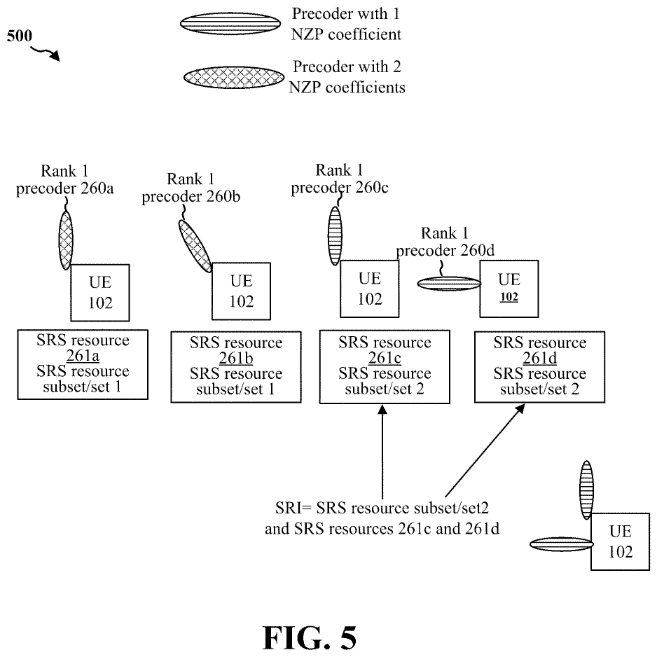

FIG. 5 illustrates a diagram 500 of SRS resource sets for non-codebook based transmission with DFT-s-OFDM waveform according to an embodiment. In some aspects, the network entity configures resource sets in which different sets correspond to a different number of layers. The network entity may configure the number of layers or number of indicated SRS resources for each SRS resource set. Alternatively, the network entity may configure the maximum number of layers or maximum number of indicated SRS resources for each SRS resource set. The UE may determine the NZP coefficients for the precoder for the SRS resources in different SRS resource sets based on the maximum number of layers or maximum number of indicated SRS resources. In the nonlimiting example of FIG. 5, the network entity configures SRS resources 261a and 261b in a first set of SRS resources (e.g., SRS resource set 1) for rank one transmission using rank 1 precoders 260a and 260b, respectively, and SRS resources 261c and 261d in a second set of SRS resources (e.g., SRS resource set 2) for rank two transmission using rank 1 precoders 260c and 260d, respectively. In some aspects, the network entity indicates the number of layers by indicating the set of SRS resources. The network entity may transmit an SRI to the UE indicating an index of the resource set. For example, when the SRI indicates an index corresponding to the first SRS set, the UE may select a precoder for the PUSCH using one layer and SRS resources 261a and 261b. When the SRI indicates an index corresponding to the second SRS set, the UE may select a precoder for the PUSCH using two layers and SRS resources 261c and 261d.

Additionally or alternatively, the SRS resources includes a single SRS resource set and the SRS resources are indicated as a subset of the SRS resource set. For example, SRS resources 261a and 261b may be in a first subset of the set of SRS resources (e.g., SRS resource subset 1) and SRS resources 261c and 261d may be in a second subset of the set of SRS resources (e.g., SRS resource subset 2).

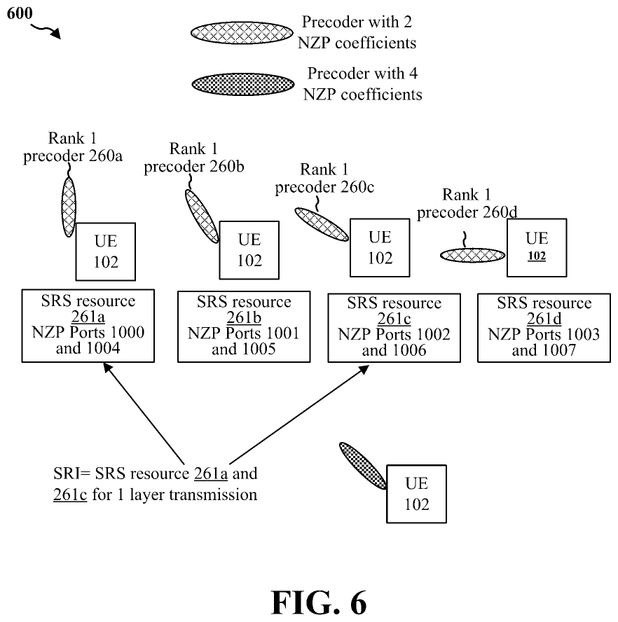

FIG. 6 illustrates a diagram 600 of NZP port combinations of SRS resources for non-codebook based transmission with DFT-s-OFDM waveform according to an embodiment. In some aspects, the UE may transmit the SRSs using orthogonal NZP PUSCH ports. In the nonlimiting example of FIG. 6, the network entity configures SRS resource 261a using rank 1 precoder 260a for NZP ports 1000 and 1004, SRS resource 261b using rank 1 precoder 260b for NZP ports 1001 and 1005, SRS resource 261c using rank 1 precoder 260c for NZP ports 1002 and 1006, and SRS resource 261d using rank 1 precoder 260d for NZP ports 1003 and 1007. The network entity may indicate the selected SRS resource(s), the SRS resource(s) for each layer and/or a number of layers in the uplink grant. In some aspects, the network entity may further indicate the combining factor(s) or phase(s) for the selected SRS resources for each layer in the uplink grant. For example, the network entity may indicate a transmit precoding matrix indicator (TPMI) corresponding to a rank 1 precoder for coherent transmission (e.g., all the coefficients in the precoder are NZP) based on a codebook for K antenna ports if K SRS resources for each layer is selected. In the example of FIG. 6, the network entity transmits an SRI indicating SRS resources 261a and 261c for a rank one transmission. The UE may transmit the PUSCH using a combined precoder on antenna ports 1000, 1002, 1004, and 1006.

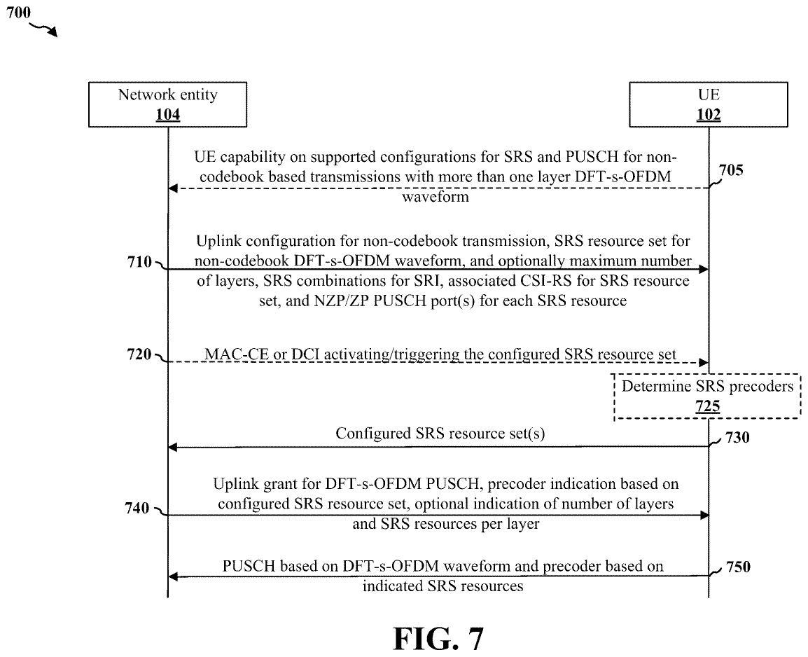

FIG. 7 is a signaling diagram 700 illustrating multi-layer non-codebook based transmission with DFT-s-OFDM waveform according to an embodiment. The UE 102 may transmit 705, to the network entity 104, a UE capability report on supported configurations for multi-layer non-codebook based transmission of SRS and PUSCH with DFT-s-OFDM waveform. The UE capability report may indicate UE capabilities, such as whether the UE 102 supports multi-layer non-codebook based transmission of SRS and PUSCH with DFT-s-OFDM waveform, a number of antenna ports of the UE 102, a maximum number of supported layers for a DFT-s-OFDM waveform, a maximum number of supported SRS resources, support for transmitting SRSs in overlapping symbols, and/or a power scaling factor associated with the antenna ports of the UE 102. In some aspects, the network entity 104 may receive the indication of the UE capability from a core network, such as from an access and mobility management function (AMF). In yet other implementations, the network entity 104 may receive the indication of the UE capability from another base station/network entity (e.g., a gNB or an eNB).

The network entity 104 transmits 710, to the UE 102, a configuration indicating the maximum number of layers for DFT-s-OFDM waveform, the maximum number of indicated SRS resources for non-codebook based transmission with DFT-s-OFDM waveform, a number of SRS resources per layer or across layers, a maximum number of candidate SRS resource combinations per rank or across all ranks, PUSCH being configured for the non-codebook based transmission, combinations of SRS resources associated with the SRI, a CSI-RS associated with the SRS resource set, an NZP PUSCH port for each SRS resource, a ZP PUSCH port for each SRS resource, and/or a target waveform for the SRS resource set (e.g., DFT-s-OFDM or CP-OFDM). In this regard, the network entity 104 may transmit 710 the configuration to the UE 102 via RRC messaging, a MAC-CE, or DCI. In some implementations, the network entity may refrain from configuring the UE for non-codebook based transmission with DFT-s-OFDM waveform when the maximum number of layers for the DFT-s-OFDM waveform is greater than 1. Thus, the UE may not expect the network entity to configure the UE for non-codebook based transmission scheme for DFT-s-OFDM waveform when the maximum number of layers for DFT-s-OFDM waveform is greater than 1.

The network entity 104 transmits 720, to the UE 102, an indicator to trigger the UE to transmit SRSs using the configured SRS resource sets. In this regard, the network entity may transmit the indicator to the UE 102 via MAC-CE or DCI.

The UE determines 725 precoder(s) for the SRS transmission. In some aspects, the UE may determine precoders for the SRS transmission as described with reference to FIGS. 2-6. Additionally or alternatively, the UE may determine a precoder (e.g., a second precoder) for PUSCH transmission based on a reference precoder (e.g., a first precoder). The reference precoder may be the precoder indicated by SRI for transmitting the SRS resources. In some aspects, the reference precoder may be similar to or the same as the precoder applied to the SRS resources for non-codebook based transmission with CP-OFDM waveform. In some aspects, the UE may not use the same precoder for the indicated SRS resources to transmit the PUSCH, instead the UE may identify a precoder that maintains the principle of one antenna port mapped to no more than one layer. The UE may select the precoder for transmissions of more than one layer and use the same precoder as the indicated SRS resource for transmission of one layer.

In some aspects, the UE may select the precoder from a codebook stored in the UE for the same number of layers as the number of layers in the indicated SRS resources. In one example, the UE may select the precoder as shown in equation 1:

$$W = {argmax}_{w ∈ C} {log}_{2} det ( {I}_{M} + {( {V}^{H} w )}^{H} ( {V}^{H} w ) ) \qquad ( 1 )$$

Where C indicates the codebook stored in the UE for the same number of layers as the number of indicated SRS resources (M); I_{M} is an M by M identity matrix; V is the precoder for the indicated SRS resources; det (A) indicates determinant of matrix A; A^{H} indicates conjugate transpose of matrix A.

Since the UE may use a precoder different from the precoder applied to the indicated SRS resources, the network entity may apply a backoff for Modulation Order and Coding Scheme (MCS) selection (e.g., a lower MCS index). In some aspects, the network entity may indicate (e.g., via RRC messaging, MAC CE, or DCI) to the UE 102 whether the UE 102 should use the same precoder as the indicated SRS resource(s) or the UE 102 may determine the precoder based on the precoder for the indicated SRS resource(s) as a reference precoder. If the network entity 104 does not provide the indication, the UE 102 may refrain from determining the precoder based on the reference precoder for the indicated SRS resource(s).

In some aspects, the UE 102 may indicate to the network entity 104 whether the UE 102 uses the same precoder as the indicated SRS resource(s) or the UE determines the precoder based on the reference precoder for the indicated SRS resource(s).

The UE 102 transmits 730, to the network entity 104, SRSs based on the configured SRS resource set(s). In some aspects, the UE 102 transmits the SRSs as described with reference to FIGS. 2-6. In some aspects, the UE 102 may indicate to the network entity 104 whether the UE 102 supports transmitting SRSs in partially or fully overlapping symbols in the time domain. The network entity 104 may refrain from configuring the SRS resources in an SRS resource set in overlapping symbols based on whether the UE 102 supports transmitting SRSs in overlapping symbols.

In some aspects, the UE 102 determines the transmission power scaling factor for each antenna port based on an equal division of the transmission power for the SRS resource and the number of antenna ports for the SRS resource. In one example, the transmission power for each port of the SRS resource is P_{Tx}/Nₚ, where P_{Tx} indicates the linear transmission power for the SRS resource, which is determined based on the uplink power control parameters for the SRS resource (e.g., as defined in 3GPP TS 38.213, section 7.3.1), and Nₚ indicates the configured number of antenna ports for the SRS resource.

In some aspects, the UE 102 determines the transmission power scaling factor for each antenna port based on an equal division of the transmission power for the SRS resource and the maximum number of antenna ports for the SRS resources in the same SRS resource set including the SRS resource. In one example, the transmission power for each port of the SRS resource is

$${P}_{Tx} / {N}_{p}^{max} ,$$

where P_{Tx} indicates the linear transmission power for the SRS resource, which is determined based on the uplink power control parameters for the SRS resource (e.g., as defined in 3GPP TS 38.213, section 7.3.1), and

$${N}_{p}^{max}$$

indicates the maximum number of antenna ports for the SRS resources in the same SRS resource set as the SRS resource.

In some aspects, the UE 102 determines the transmission power scaling factor for each port based on an equal division of the transmission power for the SRS resource and the maximum number of supported antenna ports for an SRS resource. In one example, the transmission power for each port of the SRS resource is

$${P}_{Tx} / {N}_{p}^{cap} ,$$

where P_{Tx} indicates the linear transmission power for the SRS resource, which is determined based on the uplink power control parameters for the SRS resource (e.g., as defined in 3GPP TS 38.213, section 7.3.1), and

$${N}_{p}^{cap}$$

indicates the maximum number of antenna ports for an SRS resource.

The network entity 104 transmits 740, to the UE 102, an uplink grant for a DFT-s-OFDM PUSCH indicating time/frequency resources, an SRI indicating a precoder, optionally an indication of a number of layers for the PUSCH, and the number of SRS resources per layer. In this regard, the network entity 104 may transmit 740 the uplink grant to the UE 102 via DCI.

The UE 102 transmits 750, to the network entity 104, a PUSCH based on a DFT-s-OFDM waveform and a precoder based on the indicated SRS resources. The precoder may be indicated by the SRI received in the uplink grant. In some aspects, the UE 102 transmits the PUSCH to the network entity 104 as described with reference to FIGS. 2-6.

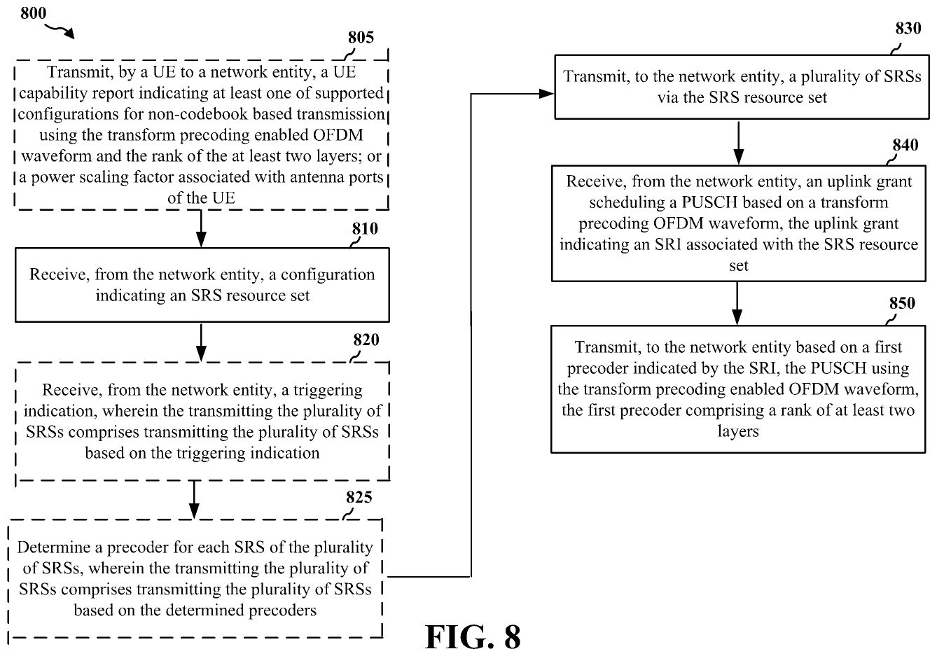

FIG. 8 illustrates a flowchart 800 of a method of wireless communication at a UE. With reference to FIGS. 1-7, the method may be performed by the UE 102 and/or the UE apparatus 1002.

The UE 102 transmits 805, to a network entity, a UE capability report indicating at least one of supported configurations for non-codebook based transmission using the transform precoding enabled OFDM waveform and the rank of the at least two layers or a power scaling factor associated with antenna ports of the UE 102. For example, referring to FIG. 7, the UE 102 transmits 705, to the network entity 104, a UE capability on supported configurations for SRS and PUSCH for non-codebook based transmissions with more than one layer DFT-s-OFDM waveform.

The UE 102 receives 810, from the network entity, a configuration indicating an SRS resource set. For example, referring to FIG. 7, the UE 102 receives 710, from the network entity 104, an uplink configuration for non-codebook transmission, SRS resource set for non-codebook DFT-s-OFDM waveform, and optionally a maximum number of layers, SRS combinations for SRI, associated CSI-RS for SRS resource set, and NZP/ZP PUSCH port(s) for each SRS resource.

The UE 102 receives 820, from the network entity, a triggering indication, wherein the transmitting the plurality of SRSs comprises transmitting the plurality of SRSs based on the triggering indication. For example, referring to FIG. 7, the UE 102 receives 720, from the network entity 104, a MAC-CE or DCI activating/triggering the configured SRS resource set.

The UE 102 determines 825, a precoder for each SRS of the plurality of SRSs, wherein the transmitting the plurality of SRSs comprises transmitting the plurality of SRSs based on the determined precoders. For example, referring to FIG. 7, the UE 102 determines 725, a precoder for each SRS of the plurality of SRSs.

The UE 102 transmits 830, to the network entity, a plurality of SRSs via the SRS resource set. For example, referring to FIG. 7, the UE 102 transmits 730, to the network entity 104, the configured SRS resource set using the determined precoders.

The UE 102 receives 840, from the network entity, an uplink grant scheduling a PUSCH based on a transform precoding enabled OFDM waveform, the uplink grant indicating an SRI associated with the SRS resource set. For example, referring to FIG. 7, the UE 102 receives 740 an uplink grant for a DFT-s-OFDM PUSCH, a precoder indication based on the configured SRS resource set, and an optional indication of a number of layers and SRS resources per layer.

The UE 102 transmits 850, to the network entity based on a first precoder indicated by the SRI, the PUSCH using the transform precoding enabled OFDM waveform, the first precoder comprising a rank of at least two layers. For example, referring to FIG. 7, the UE 102 transmits 750 a multi-layer PUSCH based on DFT-s-OFDM waveform and a precoder based on the indicated SRS resources.

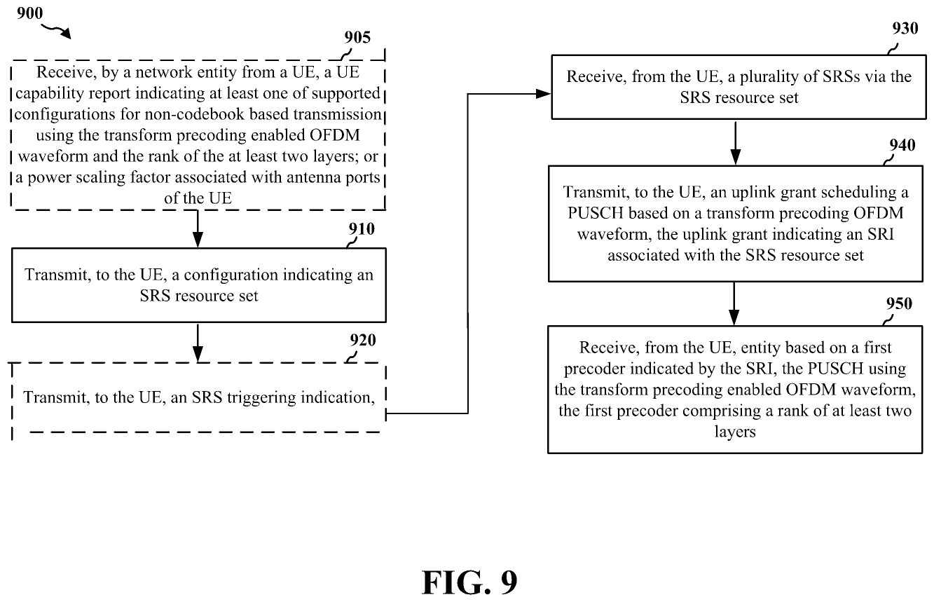

FIG. 8 describes a method from a UE-side of a wireless communication link, whereas FIG. 9 describes a method from a network-side of the wireless communication link.

FIG. 9 illustrates a flowchart 900 of a method of wireless communication at a network entity. With reference to FIGS. 1-7, the method may be performed by the network entity 104 and/or the network entity 1104.

The network entity 104 receives 905, from a UE, a UE capability report indicating at least one of supported configurations for non-codebook based transmission using the transform precoding enabled OFDM waveform and the rank of the at least two layers, or a power scaling factor associated with antenna ports of the UE 102. For example, referring to FIG. 7, the network entity 104 receives 705, from the UE 102, a UE capability on supported configurations for SRS and PUSCH for non-codebook based transmissions with more than one layer DFT-s-OFDM waveform.

The network entity 104 transmits 910, to the UE, a configuration indicating an SRS resource set. For example, referring to FIG. 7, the network entity 104 transmits 710, to the UE 102, an uplink configuration for non-codebook transmission, SRS resource set for non-codebook DFT-s-OFDM waveform, and optionally a maximum number of layers, SRS combinations for SRI, associated CSI-RS for SRS resource set, and NZP/ZP PUSCH port(s) for each SRS resource.

The network entity 104 transmits 920, to the UE, as SRS triggering indication. For example, referring to FIG. 7, the network entity 104 transmits 720, to the UE 102, a MAC-CE or DCI activating/triggering the configured SRS resource set.

The network entity 104 receives 930, from the UE, a plurality of SRSs via the SRS resource set. For example, referring to FIG. 7, the network entity 104 receives 730, from the UE 102, the configured SRS resource set using the indicated precoders.

The network entity 104 transmits 940, to the UE, an uplink grant scheduling a PUSCH based on a transform precoding enabled OFDM waveform, the uplink grant indicating an SRI associated with the SRS resource set. For example, referring to FIG. 7, the network entity 104 transmits 740, to the UE 102 an uplink grant for a DFT-s-OFDM PUSCH, a precoder indication based on the configured SRS resource set, and an optional indication of a number of layers and SRS resources per layer.

The network entity 104 receives 950, from the UE based on a first precoder indicated by the SRI, the PUSCH using the transform precoding enabled OFDM waveform, the first precoder comprising a rank of at least two layers. For example, referring to FIG. 7, the network entity 104 receives 750, from the UE 102 a PUSCH based on DFT-s-OFDM waveform and a precoder based on the indicated SRS resources.

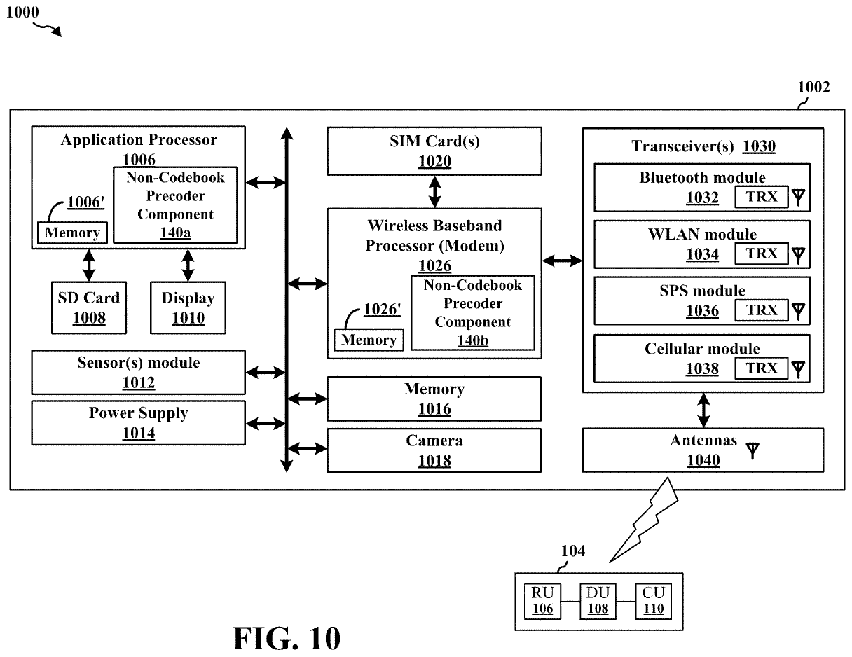

FIG. 10 is a diagram 1000 illustrating an example of a hardware implementation for a UE apparatus 1002. The UE apparatus 1002 may be the UE 102, a component of the UE 102, or may implement UE functionality. The UE apparatus 1002 may include an application processor 1006, which may have on-chip memory 1006′. In examples, the application processor 1006 may be coupled to a secure digital (SD) card 1008 and/or a display 1010. The application processor 1006 may also be coupled to a sensor(s) module 1012, a power supply 1014, an additional module of memory 1016, a camera 1018, and/or other related components.

The UE apparatus 1002 may further include a wireless baseband processor 1026, which may be referred to as a modem. The wireless baseband processor 1026 may have on-chip memory 1026′. Along with, and similar to, the application processor 1006, the wireless baseband processor 1026 may also be coupled to the sensor(s) module 1012, the power supply 1014, the additional module of memory 1016, the camera 1018, and/or other related components. The wireless baseband processor 1026 may be additionally coupled to one or more subscriber identity module (SIM) card(s) 1020 and/or one or more transceivers 1030 (e.g., wireless RF transceivers).

Within the one or more transceivers 1030, the UE apparatus 1002 may include a Bluetooth module 1032, a WLAN module 1034, an SPS module 1036 (e.g., GNSS module), and/or a cellular module 1038. The Bluetooth module 1032, the WLAN module 1034, the SPS module 1036, and the cellular module 1038 may each include an on-chip transceiver (TRX), or in some cases, just a transmitter (TX) or just a receiver (RX). The Bluetooth module 1032, the WLAN module 1034, the SPS module 1036, and the cellular module 1038 may each include dedicated antennas and/or utilize antennas 1040 for communication with one or more other nodes. For example, the UE apparatus 1002 can communicate through the transceiver(s) 1030 via the antennas 1040 with another UE (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 1026 and the application processor 1006 may each include a computer-readable medium/memory 1026′, 1006′, respectively. The additional module of memory 1016 may also be considered a computer-readable medium/memory. Each computer-readable medium/memory 1026′, 1006′, 1016 may be non-transitory. The wireless baseband processor 1026 and the application processor 1006 may each be responsible for general processing, including execution of software stored on the computer-readable medium/memory 1026′, 1006′, 1016. The software, when executed by the wireless baseband processor 1026/application processor 1006, causes the wireless baseband processor 1026/application processor 1006 to perform the various functions described herein. The computer-readable medium/memory may also be used for storing data that is manipulated by the wireless baseband processor 1026/application processor 1006 when executing the software. The wireless baseband processor 1026/application processor 1006 may be a component of the UE 102. The UE apparatus 1002 may be a processor chip (e.g., modem and/or application) and include just the wireless baseband processor 1026 and/or the application processor 1006. In other examples, the UE apparatus 1002 may be the entire UE 102 and include the additional modules of the apparatus 1002.

As discussed in FIG. 1 and implemented with respect to FIG. 8, the non-codebook precoder component 140 is configured to receive, from a network entity, a configuration indicating an SRS resource set. The non-codebook precoder component 140 is further configured to transmit, to the network entity, a plurality of SRSs via the SRS resource set. The non-codebook precoder component 140 is further configured to receive, from the network entity, an uplink grant scheduling a PUSCH based on a transform precoding enabled OFDM waveform, the uplink grant indicating an SRI associated with the SRS resource set. The non-codebook precoder component 140 is further configured to transmit, to the network entity based on a first precoder indicated by the SRI, the PUSCH using the transform precoding enabled OFDM waveform, the first precoder comprising a rank of at least two layers. The non-codebook precoder component 140 may be within the application processor 1006 (e.g., at 140a), the wireless baseband processor 1026 (e.g., at 140b), or both the application processor 1006 and the wireless baseband processor 1026. The non-codebook precoder component 140a-140b may be one or more hardware components specifically configured to carry out the stated processes/algorithm, implemented by one or more processors configured to perform the stated processes/algorithm, stored within a computer-readable medium for implementation by the one or more processors, or a combination thereof.

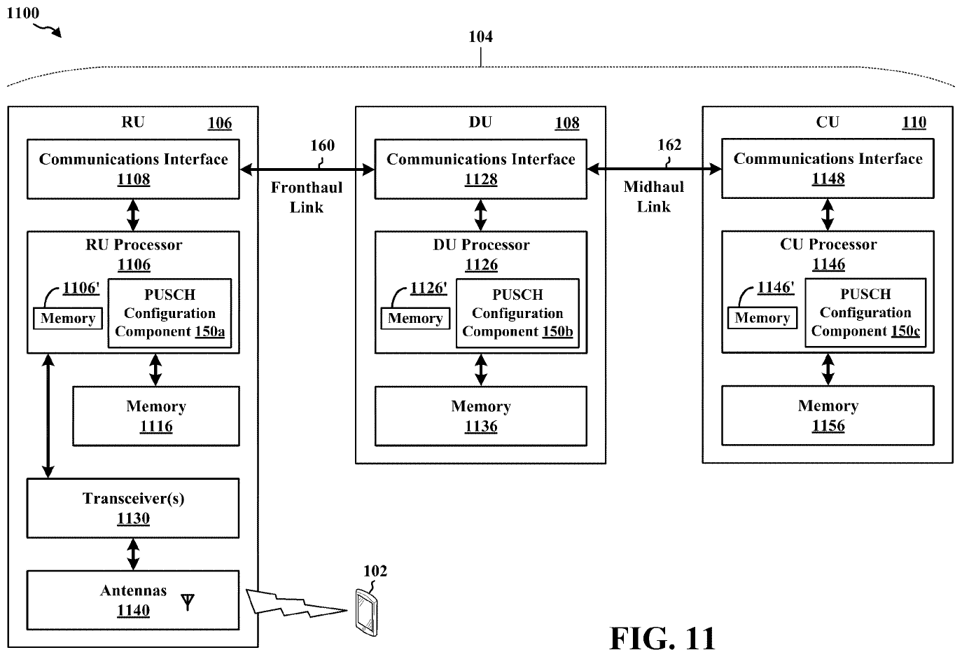

FIG. 11 is a diagram 1100 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 1146, which may have on-chip memory 1146′. In some aspects, the CU 110 may further include an additional module of memory 1156 and/or a communications interface 1148, both of which may be coupled to the CU processor 1146. The CU 110 can communicate with the DU 108 through a midhaul link 162, such as an F1 interface between the communications interface 1148 of the CU 110 and a communications interface 1128 of the DU 108.

The DU 108 may include a DU processor 1126, which may have on-chip memory 1126′. In some aspects, the DU 108 may further include an additional module of memory 1136 and/or the communications interface 1128, both of which may be coupled to the DU processor 1126. The DU 108 can communicate with the RU 106 through a fronthaul link 160 between the communications interface 1128 of the DU 108 and a communications interface 1108 of the RU 106.

The RU 106 may include an RU processor 1106, which may have on-chip memory 1106′. In some aspects, the RU 106 may further include an additional module of memory 1116, the communications interface 1108, and one or more transceivers 1130, all of which may be coupled to the RU processor 1106. The RU 106 may further include antennas 1140, which may be coupled to the one or more transceivers 1130, such that the RU 106 can communicate through the one or more transceivers 1130 via the antennas 1140 with the UE 102.

The on-chip memory 1106′, 1126′, 1146′ and the additional modules of memory 1116, 1136, 1156 may each be considered a computer-readable medium/memory. Each computer-readable medium/memory may be non-transitory. Each of the processors 1106, 1126, 1146 is responsible for general processing, including execution of software stored on the computer-readable medium/memory. The software, when executed by the corresponding processor(s) 1106, 1126, 1146 causes the processor(s) 1106, 1126, 1146 to perform the various functions described herein. The computer-readable medium/memory may also be used for storing data that is manipulated by the processor(s) 1106, 1126, 1146 when executing the software. In examples, the < > component 150 may sit at any of the one or more network entities 104, such as at the CU 110; both the CU 110 and the DU 108; each of the CU 110, the DU 108, and the RU 106; the DU 108; both the DU 108 and the RU 106; or the RU 106.

As discussed in FIG. 1 and implemented with respect to FIG. 9, the PUSCH configuration component 150 is configured to transmit, to a UE, a configuration indicating an SRS resource set. The PUSCH configuration component 150 is further configured to receive, from the UE, a plurality of SRSs via the SRS resource set. The PUSCH configuration component 150 is further configured to transmit, to the UE, an uplink grant scheduling a PUSCH based on a transform precoding enabled OFDM waveform, the uplink grant indicating an SRI associated with the SRS resource set. The PUSCH configuration component 150 is further configured to receive, from the UE based on a first precoder indicated by the SRI, the PUSCH using the transform precoding enabled OFDM waveform, the first precoder comprising a rank of at least two layers. The PUSCH configuration component 150 may be within one or more processors of the one or more network entities 104, such as the RU processor 1106 (e.g., at 150a), the DU processor 1126 (e.g., at 150b), and/or the CU processor 1146 (e.g., at 150c). The PUSCH configuration component 150a-150c may be one or more hardware components specifically configured to carry out the stated processes/algorithm, implemented by one or more processors 1106, 1126, 1146 configured to perform the stated processes/algorithm, stored within a computer-readable medium for implementation by the one or more processors 1106, 1126, 1146, or a combination thereof.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The terms “may”, “might”, and “can”, as used in this disclosure, often carry certain connotations. For example, “may” refers to a permissible feature that may or may not occur, “might” refers to a feature that probably occurs, and “can” refers to a capability (e.g., capable of). The phrase “For example” often carries a similar connotation to “may” and, therefore, “may” is sometimes excluded from sentences that include “for example” or other similar phrases.

Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more. Terms or articles such as “a”, “an”, and/or “the” may refer to one of an item, feature, element, etc., that the term or article precedes, or may refer to more than one of said item, feature, element, etc. that the term or article precedes. For example, the recitation “a widget” does not preclude reference to multiples of said widget, as “multiple widgets” necessarily includes “a widget”. Hence, the recitation “a widget” may be interpreted as “at least one widget” or, similarly, interpreted as “one or more widgets”.

Unless otherwise specifically indicated, ordinal terms such as “first” and “second” do not necessarily imply an order in time, sequence, numerical value, etc., but are used to distinguish between different instances of a term or phrase that follows each ordinal term. Reference numbers, as used in the specification and figures, are sometimes cross-referenced among drawings to denote same or similar features. A feature that is exactly the same in multiple drawings may be labeled with the same reference number in the multiple drawings. A feature that is similar among the multiple drawings, but not exactly the same, may be labeled with reference numbers that have different leading numbers, but have one or more of the same trailing numbers (e.g., 206, 306, 406, etc., may refer to similar features in the drawings).

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a UE, comprising receiving, from a network entity, a configuration indicating an SRS resource set; transmitting, to the network entity, a plurality of SRSs via the SRS resource set; receiving, from the network entity, an uplink grant scheduling a PUSCH using a transform precoding enabled OFDM waveform, the uplink grant indicating an SRI based on the SRS resource set; and transmitting, to the network entity, the PUSCH using the transform precoding enabled OFDM waveform and based on a first precoder indicated by the SRI, the first precoder comprising a rank of at least two layers.

Example 2 may be combined with Example 1 and includes the transmitting the PUSCH comprises transmitting each layer of the PUSCH via a different antenna port.

Example 3 may be combined with Example 2 and further includes determining a precoder for each SRS of the plurality of SRSs, wherein the transmitting the plurality of SRSs comprises transmitting the plurality of SRSs based on the determined precoders.

Example 4 may be combined with any of Examples 1-3 and further includes the precoder for each SRS comprises a combination of SRS resources and each SRS of the combination of SRS resources is associated with a different antenna port.

Example 5 may be combined with any of Examples 1~4 and further includes comprising transmitting, to the network entity, a UE capability report indicating at least one of supported configurations for non-codebook based transmission using the transform precoding enabled OFDM waveform and the rank of at least two layers; or a power scaling factor associated with antenna ports of the UE.

Example 6 may be combined with any of Examples 1~4 and further includes receiving, from the network entity, a triggering indication, wherein the transmitting the plurality of SRSs comprises transmitting the plurality of SRSs in response to the triggering indication.

Example 7 may be combined with any of Examples 1-6 and further includes the configuration further indicates at least one of a maximum number of layers for a discrete Fourier transform spread OFDM (DFT-s-OFDM) waveform, a maximum number of indicated SRS resources for non-codebook based transmission with the DFT-s-OFDM waveform; a number of SRS resources per layer; the PUSCH being configured for a non-codebook based transmission; combinations of SRS resource associated with the SRI; a CSI RS associated with the SRS resource set; a non-zero power PUSCH port for each SRS resource; a zero power PUSCH port for each SRS resource; or a target waveform for the SRS resource set, the target waveform including at least one of the DFT-s-OFDM waveform or a CP-OFDM waveform.

Example 8 may be combined with any of Examples 1-7 and further includes the receiving the configuration comprises receiving the configuration via at least one of RRC signaling, a MAC-CE, or DCI.

Example 9 may be combined with any of Examples 1-8 and further includes the configuration further indicates the SRS resource set as a first SRS resource set associated with the transform precoding enabled OFDM waveform; and a second SRS resource set associated with a transform precoding disabled OFDM waveform.

Example 10 may be combined with any of Examples 1-9 and further includes the configuration further indicates the SRS resource set as a common SRS resource set associated with the transform precoding enabled OFDM waveform and a transform precoding disabled OFDM waveform.

Example 11 may be combined with any of Examples 1-10 and further includes the configuration further indicates the SRS resource set is configured for a plurality of antenna ports; the transmitting the plurality of SRSs comprises transmitting the plurality of SRSs via the plurality of antenna ports; the SRI indicates one or more antenna ports of the plurality of antenna ports; and the transmitting the PUSCH comprises transmitting the PUSCH via the indicated one or more antenna ports of the plurality of antenna ports.

Example 12 may be combined with any of Examples 1-11 and further includes the SRS resource set comprises non-overlapping SRS resources in a time domain.

Example 13 may be combined with any of Examples 1-12 and further includes the transmitting the plurality of SRSs comprises transmitting each of the plurality of SRSs at an equal power level based on a transmission power for the SRS resource set and at least one of a number of antenna ports configured for the transmitting the plurality of SRSs; or a maximum number of antenna ports associated with the UE.

Example 14 may be combined with any of Examples 1-13 and further includes wherein the SRI indicates at least one of an index indicating a combination of SRS resources associated with different antenna ports; a subset of the SRS resources; or at least one SRS resource.

Example 15 may be combined with any of Examples 1-14 and further includes selecting, from a codebook, a second precoder based on the first precoder indicated by the SRI, wherein the transmitting the PUSCH comprises transmitting the PUSCH using the second precoder.

Example 16 may be combined with any of Examples 1-15 and further includes transmitting, to the network entity, an indication of the second precoder.

Example 17 is a method of wireless communication at a network entity comprising transmitting, to a UE, a configuration indicating SRS resource set; receiving, from the UE, a plurality of SRSs via the SRS resource set; transmitting, to the UE, an uplink grant scheduling a PUSCH using a transform precoding enabled OFDM waveform, wherein the uplink grant indicates an SRI based on the SRS resource set; and receiving, from the UE, the PUSCH using the transform precoding enabled OFDM waveform and based on a precoder indicated by the SRI, wherein the precoder comprises a rank of at least two layers

Example 18 may be combined with Example 17 and further includes receiving, from the UE, a UE capability report indicating at least one of supported configurations for non-codebook based transmission of the PUSCH using the transform precoding enabled OFDM waveform and the rank of at least two layers; or a power scaling factor associated with antenna ports of the UE.

Example 19 may be combined with any of Examples 17-18 and further includes transmitting, to the UE, a triggering indication associated with the plurality of SRSs.

Example 20 may be combined with any of Examples 17-19 and further includes the configuration further indicates at least one of a maximum number of layers for a discrete Fourier transform spread OFDM (DFT-s-OFDM) waveform, a maximum number of indicated SRS resources for non-codebook based transmission with the DFT-s-OFDM waveform; a number of SRS resources per layer or across layers; the PUSCH being configured for a non-codebook based transmission; combinations of SRS resources associated with the SRI; a CSI RS associated with the SRS resource set; a non-zero power PUSCH port for each SRS resource; a zero power PUSCH port for each SRS resource; or a target waveform for the SRS resource set, the target waveform including at least one of the DFT-s-OFDM waveform or a CP-OFDM waveform.

Example 21 may be combined with any of Examples 17-20 and further includes the transmitting the configuration comprises transmitting the configuration via at least one of RRC signaling, a MAC-CE, or DCI.

Example 22 may be combined with any of Examples 17-21 and further includes the configuration further indicates the SRS resource set as a first SRS resource set associated with the transform precoding enabled OFDM waveform; and a second SRS resource set associated with a transform precoding disabled OFDM waveform.

Example 23 may be combined with any of Examples 17-22 and further includes the configuration further indicates the SRS resource set as a common SRS resource set associated with the transform precoding enabled OFDM waveform and a transform precoding disabled OFDM waveform.

Example 24 may be combined with any of Examples 17-23 and further includes the configuration further indicates the SRS resource set is configured for a plurality of UE antenna ports; the receiving the plurality of SRSs comprises receiving the plurality of SRSs via the plurality of UE antenna ports; and the SRI indicates one or more antenna ports of the plurality of UE antenna ports.

Example 25 may be combined with any of Examples 17-24 and further includes the SRS resource set comprises non-overlapping SRS resources in a time domain.

Example 26 may be combined with any of Examples 17-25 and further includes the SRI indicates at least one of an index indicating a combination of SRS resources associated with different UE antenna ports; a subset of the SRS resources; or at least one SRS resource.

Example 27 may be combined with any of Examples 17-26 and further includes receiving, from the UE, an indication of a second precoder, wherein the receiving the PUSCH comprises receiving the PUSCH using the second precoder.

Example 28 is an apparatus for wireless communication for implementing a method as in any of Examples 1-27.

Example 29 is an apparatus for wireless communication including means for implementing a method as in any of Examples 1-27.

Example 30 is a non-transitory computer-readable medium storing computer executable code, the code when executed by a processor causes the processor to implement a method as in any of Examples 1-27.

What is claimed is:

1. A method of wireless communication at a user equipment (UE), comprising:
receiving, from a network entity, a configuration indicating:
a sounding reference signal (SRS) resource set, and
at least a non-zero power (NZP) physical uplink shared channel (PUSCH) port associated with each SRS resource in the SRS resource set;
transmitting, to the network entity, a plurality of SRSs via the SRS resource set;
receiving, from the network entity, an uplink grant scheduling a PUSCH based on a transform precoding enabled orthogonal frequency division multiplexing (OFDM) waveform, the uplink grant indicating an SRS resource indicator (SRI) associated with the SRS resource set; and
transmitting, to the network entity based on a first precoder indicated by the SRI, the PUSCH using the transform precoding enabled OFDM waveform, the first precoder comprising a rank of at least two layers.

2. The method of claim 1, wherein the transmitting the PUSCH comprises transmitting on each layer of the PUSCH via a different antenna port.

3. The method of claim 1, further comprising determining a precoder for each SRS of the plurality of SRSs, wherein the transmitting the plurality of SRSs comprises transmitting the plurality of SRSs based on the determined precoders.

4. The method of claim 3, wherein the precoder for each SRS comprises a combination of SRS resources and each SRS of the combination of SRS resources is associated with a different antenna port.

5. The method of claim 1, further comprising transmitting, to the network entity, a UE capability report indicating at least one of:
supported configurations for non-codebook based transmission using the transform precoding enabled OFDM waveform and the rank of the at least two layers; or
a power scaling factor associated with antenna ports of the UE.

6. The method of claim 1, further comprising receiving, from the network entity, a triggering indication, wherein the transmitting the plurality of SRSs comprises transmitting the plurality of SRSs based on the triggering indication.

7. The method of claim 1, wherein the configuration further indicates at least one of:
a maximum number of layers for a discrete Fourier transform spread OFDM (DFT-s-OFDM) waveform;
a maximum number of indicated SRS resources for non-codebook based transmission with the DFT-s-OFDM waveform;
a number of SRS resources per layer or across layers;
the PUSCH being configured for the non-codebook based transmission;
combinations of SRS resources associated with the SRI;
a channel state information reference signal (CSI-RS) associated with the SRS resource set;
a zero power (ZP) PUSCH port for each SRS resource; or
a target waveform for the SRS resource set, the target waveform including at least one of the DFT-s-OFDM waveform or a cyclic prefix OFDM (CP-OFDM) waveform.

8. The method of claim 1, wherein the receiving the configuration comprises receiving the configuration via at least one of a radio resource control (RRC) message, a medium access control-control element (MAC-CE), or downlink control information (DCI).

9. The method of claim 1, wherein the configuration further indicates the SRS resource set as:
a first SRS resource set associated with the transform precoding enabled OFDM waveform; and
a second SRS resource set associated with a transform precoding disabled OFDM waveform, the second SRS resource set being different from the first SRS resource set.

10. The method of claim 1, wherein the configuration further indicates:
the SRS resource set as a common SRS resource set associated with the transform precoding enabled OFDM waveform and a transform precoding disabled OFDM waveform.

11. The method of claim 1, wherein:
the configuration further indicates the SRS resource set is configured for a plurality of antenna ports;
the transmitting the plurality of SRSs comprises transmitting the plurality of SRSs via the plurality of antenna ports;
the SRI indicates one or more antenna ports of the plurality of antenna ports; and
the transmitting the PUSCH comprises transmitting the PUSCH via the indicated one or more antenna ports of the plurality of antenna ports.

12. The method of claim 1, wherein the SRS resource set comprises non-overlapping SRS resources in a time domain.

13. The method of claim 1, wherein the transmitting the plurality of SRSs comprises transmitting each of the plurality of SRSs at an equal power level based on a transmission power for the SRS resource set and at least one of:
a number of antenna ports configured for the transmitting the plurality of SRSs; or
a maximum number of antenna ports associated with the UE.

14. The method of claim 1, wherein the SRI indicates at least one of:
an index indicating a combination of SRS resources associated with different antenna ports; or
at least one SRS resource.

15. The method of claim 1, further comprising:
selecting, from a codebook, a second precoder based on the first precoder indicated by the SRI, wherein the transmitting the PUSCH comprises transmitting the PUSCH using the second precoder; and
transmitting, to the network entity, an indication of the second precoder.

16. A method of wireless communication at a network entity, comprising:
transmitting, to a user equipment (UE), a configuration indicating a sounding reference signal (SRS) resource set, the configuration including at least a non-zero power (NZP) physical uplink shared channel (PUSCH) port for each SRS resource;
receiving, from the UE, a plurality of SRSs via the SRS resource set;
transmitting, to the UE, an uplink grant scheduling a (PUSCH) based on a transform precoding enabled orthogonal frequency division multiplexing (OFDM) waveform, the uplink grant indicating an SRS resource indicator (SRI) associated with the SRS resource set; and
receiving, from the UE based on a precoder indicated by the SRI, the PUSCH using the transform precoding enabled OFDM waveform, the precoder comprising a rank of at least two layers.

17. The method of claim 16, wherein the configuration further indicates the SRS resource set as:
a first SRS resource set associated with the transform precoding enabled OFDM waveform; and
a second SRS resource set associated with a transform precoding disabled OFDM waveform, the second SRS resource set being different from the first SRS resource set.

18. The method of claim 16, wherein the configuration further indicates:
the SRS resource set as a common SRS resource set associated with the transform precoding enabled OFDM waveform and a transform precoding disabled OFDM waveform.

19. An apparatus for wireless communication at a user equipment (UE), comprising:
a transceiver,
a memory, and
a processor coupled to the transceiver and the memory and configured to:
receive, from a network entity, a configuration indicating:
a sounding reference signal (SRS) resource set, and
at least a non-zero power (NZP) physical uplink shared channel (PUSCH) port associated with each SRS resource in the SRS resource set;
transmit, to the network entity, a plurality of SRSs via the SRS resource set;
receive, from the network entity, an uplink grant scheduling a PUSCH based on a transform precoding enabled orthogonal frequency division multiplexing (OFDM) waveform, the uplink grant indicating an SRS resource indicator (SRI) associated with the SRS resource set; and
transmit, to the network entity based on a first precoder indicated by the SRI, the PUSCH using the transform precoding enabled OFDM waveform, the first precoder comprising a rank of at least two layers.

20. The method of claim 16, wherein:
the configuration further indicates the SRS resource set is configured for a plurality of antenna ports;
the transmitting the plurality of SRSs comprises transmitting the plurality of SRSs via the plurality of antenna ports;
the SRI indicates one or more antenna ports of the plurality of antenna ports; and
the transmitting the PUSCH comprises transmitting the PUSCH via the indicated one or more antenna ports of the plurality of antenna ports.
